(19) United States
(12) Patent Application Publication
(10) Pub. No.: US 2026/0089194 A1
(43) Pub. Date: Mar. 26, 2026

(54) NETWORK-WIDE POLICY INTENT ORCHESTRATION

(71) Applicant: Hewlett Packard Enterprise Development LP, Spring, TX (US)

(72) Inventors: Senthil Kumar Veeraswamy Santhanam, Milpitas, CA (US); Piyush Agarwal, Sunnyvale, CA (US); Dhrumil Hirenkumar Desai, Fremont, CA (US); Praveen Kumar Muthuswamy, Foster City, CA (US)

(21) Appl. No.: 18/896,454

(22) Filed: Sep. 25, 2024

(51) Int. Cl. H04L 9/40

(52) U.S. Cl. CPC H04L 63/20; H04L 63/107

(57) ABSTRACT

In embodiments, a system and method for network-wide policy intent orchestration is proposed that addresses challenges in managing security policies across diverse enterprise networks. The system receives security intent-based policies defining roles, a global policy order, and policy mappings for locations and devices. It automatically derives role-specific policies based on these inputs, generating device-specific and location-specific policy configurations. The derived policies are distributed to corresponding network devices for enforcement. The approach enables consistent policy application across complex networks while allowing local customization. The system streamlines policy management, reduces errors, and enhances overall network security by centralizing policy creation and automating distribution.

### BACKGROUND

Enterprise networks have become increasingly complex, spanning multiple types of infrastructure, including wired local area networks (LANs), wireless networks (WLANs), wide area networks (WANs), and data center networks. The diverse network environments support various users, devices, and applications while maintaining consistent security policies across the organization. Role-based access control is a common approach to managing security in such networks, where users and devices are assigned roles that determine their access privileges.

In a typical enterprise setup, network edge devices like switches, gateways, and access points enforce security policies. These policies control what resources each role can access, what types of traffic are allowed or blocked, and how different network segments interact. Maintaining a coherent and uniform security posture can become increasingly challenging as organizations grow and their networks expand across multiple locations. Security administrators ensure that policies are consistently applied across all network devices while accommodating location-specific requirements and organizational hierarchies.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of an implementation network architecture system that provides comprehensive network-wide policy intent orchestration;

FIG. 2 is a flowchart of an example method for policy configuration;

FIG. 3 is a flowchart of an example method for policy generation based on the policy configuration;

FIG. 4 is a flowchart of an example method for policy distribution and enforcement;

FIG. 5 is a block diagram of an example computing device, according to certain implementations; and

FIG. 6 is a flowchart for an implementation method for managing network security policies.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the disclosure aspects are described primarily in the context of a network-wide policy intent orchestration system for enterprise networks, the disclosed techniques are not limited to this specific implementation. In particular, aspects of this disclosure may similarly apply to any large-scale network management system that desire consistent policy enforcement across diverse network environments, including but not limited to cloud-based networks, multi-tenant networks, or hybrid network architectures combining on-premises and cloud infrastructure.

In an implementation, a system and method for simplifying and ensuring consistency in network-wide policy intent orchestration are proposed. A Global Policy Manager (GPM) is introduced that utilizes a security-intent-based configuration model to address the challenges enterprises face in configuring and enforcing security policies across diverse network environments.

The GPM can allow security administrators to define policies considering multiple roles simultaneously rather than configuring policies for each role separately. The proposed approach can enable the creation of global and location-specific policies, which can be applied consistently across different network devices and geographic locations. The system can automatically merge policies, ensure correct rule ordering for various locations as intended by security admins, and predictably compose per-role definitions.

An aspect of the disclosure is introducing a global policy order among the configured policies. The global order controls the derivation of role-specific policies, ensuring that rules are consistently ordered across all roles without manual duplication. The system can automatically derive role-specific policies from the user-configured corporate and location-specific policies, tailoring them for each role, edge device, and location.

In an implementation, the GPM ensures that relevant role-specific policies are derived and distributed for locations and device types while maintaining consistency with corporate-wide rules. The proposed approach advantageously simplifies policy management for large organizations with numerous roles and diverse network environments. It can eliminate the need to send all role-specific policies to all locations and device types while still ensuring that location and device-specific role policies remain consistent with any corporate or organization-wide rules.

The system can also address the coordination challenges between security admins and network admins in large enterprises. For example, security admins can globally define policies once, while network admins from various parts of the organization can map those policies to desired locations or devices. The streamlined approach can eliminate the need for constant coordination and reduce the potential for miscommunication or errors in policy implementation.

Accordingly, in various implementations, the proposed approach provides an intuitive, efficient, and error-resistant approach for managing complex network security policies across large-scale enterprise environments. It can maintain a consistent and deterministic security posture across the entire organization while allowing for customizations at different levels of the network hierarchy. These and additional details are further detailed below.

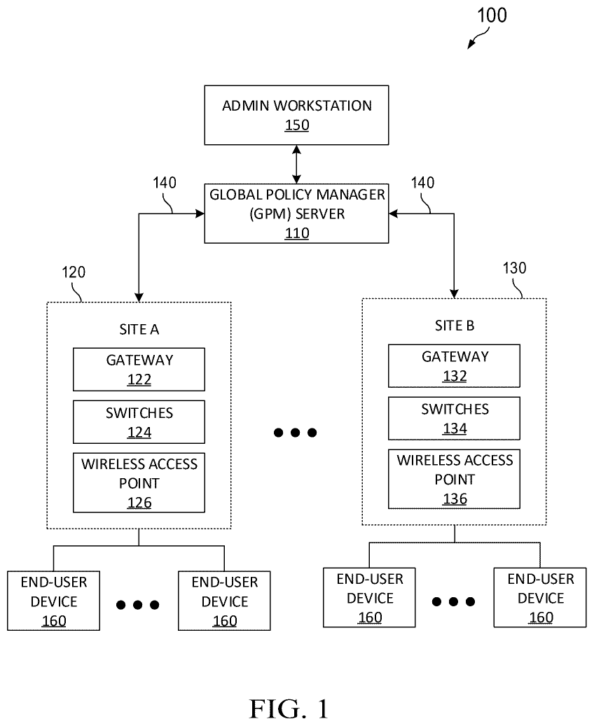

FIG. 1 illustrates a block diagram of an implementation network architecture system 100 that provides comprehensive network-wide policy intent orchestration. System 100 includes a Global Policy Manager (GPM) server 110, multiple enterprise network sites (represented by Site A 120 and Site B 130), network devices at each site (such as gateways 122/132, switches 124/134, and wireless access points 126/136), Wide Area Network (WAN) infrastructure 140, an admin workstation 150, and end-user devices 160, which may (or may not) be arranged as shown.

In an implementation, GPM server 110 hosts the centralized management functionality for policy configuration, derivation, and distribution. The GPM server 110 can include the software components and databases for managing the entire policy lifecycle. These components typically include a policy configuration interface, a policy store for storing defined policies and the global policy order, a policy derivation engine for automatically merging and deriving role-specific policies, and a policy distribution module for securely transmitting derived policies to network devices. The GPM server 110 is designed to handle large-scale policy management across diverse network environments, ensuring consistent security posture throughout the enterprise.

GPM server 110 can be implemented as a physical server or cluster of servers running, for example, a secure, enterprise-grade operating system. It houses a robust database layer for storing policies, global policy orders, and other relevant data for network-wide policy management.

For example, the GPM server 110 application layer can include a policy configuration interface for defining and managing policies, a policy store for maintaining the policy database, a policy derivation engine for automatically merging and deriving role-specific policies, and a policy distribution module for securely transmitting derived policies to network devices. These components can handle large-scale policy management across diverse network environments.

The GPM server 110 can incorporate a dedicated security layer implementing encryption and access controls and a network interface layer for communication with other system components to ensure security and efficient communication. The structure allows the GPM server 110 to centralize policy management, automate policy derivation and distribution, and maintain a consistent security posture throughout the enterprise network.

The GPM server 110 can be connected to multiple enterprise network sites. FIG. 1 illustrates two example sites: Site A 120 and Site B 130. However, it should be understood that system 100 may include fewer or more network sites depending on the specific enterprise configuration.

Each site can represent a distinct geographic location or network segment within the enterprise network. Site A 120 comprises network devices, including one or more gateways 122, one or more switches 124, and one or more wireless access points 126. Site B 130 similarly includes its own set of network devices, including one or more gateways 132, one or more switches 134, and one or more wireless access points 136. These physical devices at each site enforce the derived policies at the network edge, controlling access and traffic based on the policies distributed by the GPM server 110.

System 100 also includes WAN infrastructure 140, interconnecting the sites and the GPM server. The WAN infrastructure 140 includes routers, leased lines, and other networking equipment, facilitating secure communication and policy distribution between the GPM server 110 and network devices.

The admin workstation 150 provides access to the admin console software. Network and security administrators can use the admin workstation 150 to interact with the GPM server 110, define policies, and manage the network. The admin workstation 150 can serve as an interface for network and security administrators to interact with the system 100. It can consist of a physical computer or terminal running a secure, admin-oriented operating system. The admin workstation 150 can include an application layer that includes the admin console software, a policy definition interface, and various network management tools.

To ensure secure operations, admin workstation 150 can implement a robust security layer with strong authentication and access controls. It can also feature a network interface layer for secure communication with the GPM server 110. This enables the admin workstation 150 to provide administrators with the tools to define policies, manage the network, and oversee the implementation of network-wide policy intent orchestration.

System 100 includes end-user devices 160 coupled to the network. These physical devices, such as employee laptops, smartphones, tablets, and IoT devices, interact with the enterprise network and connect to it through each site's various access points and switches.

The communication between the GPM server 110 and the network devices at each site can be secured using industry-standard encryption protocols, ensuring that policy information is protected during transmission across the WAN infrastructure 140.

End-user devices 160 can be dynamically assigned roles based on various factors such as user identity, device type, location, and authentication method. The roles can be determined upon connection to the network and updated in real-time based on changing conditions.

System 100 can be designed to scale efficiently. New sites or devices can be easily integrated into the existing architecture, and the GPM server 110 automatically generates and distributes appropriate policies based on the global policy order and site-specific requirements. In policy conflicts or updates, the GPM server 110 can employ a resolution algorithm to enforce the most recent and highest-priority policies. The algorithm can maintain consistency across the network while allowing for site-specific variations.

System 100 may include additional components not shown, such as firewall appliances for enhanced network security, load balancers to distribute network traffic efficiently, network attached storage (NAS) devices for centralized data storage, Virtual Private Network (VPN) concentrators for secure remote access, Intrusion Detection and Prevention Systems (IDS/IPS) for monitoring and protecting against network threats, Domain Name System (DNS) servers for translating domain names to IP addresses, Dynamic Host Configuration Protocol (DHCP) servers for automatic IP address assignment, network monitoring and management servers for tracking performance and health, backup and disaster recovery systems to ensure data integrity and business continuity, physical security systems like badge readers and security cameras that may integrate with the network, and Uninterruptible Power Supply (UPS) units and backup generators to ensure continuous operation of critical network components.

To ensure high availability and continuity of policy management, the GPM server 110 may be configured with redundancy and failover capabilities. This could include a backup GPM server that can take over operations in case of server failure, ensuring uninterrupted policy enforcement across the enterprise network.

Security policy creation and enforcement can be advantageous to building enterprise zero-trust networks. System 100 represents an example of a simplified diagram of a comprehensive network architecture that can include wired networks (LAN), wireless networks (WLAN), and wide-area networks, embodied by multiple enterprise network sites such as Site A 120 and Site B 130.

The Global Policy Manager (GPM) server 110 can implement role-based security policies to identify and mitigate security threats across the network. Each client session or end-user device 160 can be assigned a role based on several system attributes. Policies are then applied at the edge devices (e.g., the gateways, switches, wireless access points, etc.) to control the resources each client session (i.e., role) can access.

Generally, the existing policy configuration model can face challenges. For example, when an employee connects to the enterprise network at any site, a particular role (e.g., employee-dev for IT or employee-hr for HR staff) may be assigned to the employee. Access rules specific to that employee role are applied at the gateway or switch to police the traffic. Similarly, when, for example, an IoT device or printer connects to the enterprise network, the corresponding role is assigned, and rules are applied. Maintaining consistent policy enforcement for roles across wired/wireless networks and different sites while allowing for site-specific customizations is advantageous but complex.

Current methods require configuring policies for each role separately and possibly for each device type and location. With enterprise networks often having thousands of roles spanning several geographic locations, the existing approaches can become complex, error-prone, and don't scale effectively. Several observations can highlight the advantages of a different policy configuration methodology.

Many roles often share similar access restrictions, with some rules applying to all employee and guest roles across wired/wireless networks and locations. Additionally, some rules can be role-agnostic and apply to all roles in the network. The ordering of rules is to be preserved across multiple role policies. For example, for all employee roles (hr/dev), it is desirable for rules allowing traffic to internal servers to be configured before rules blocking malicious traffic or access to other internal servers. Further, it is also advantageous for roles to have consistent policy enforcement across locations and edge device types while allowing for site-specific customizations, such as an employee-dev role with the same set of rules in different locations with perhaps one additional rule for a specific site. Moreover, in large organizations with thousands of roles, certain roles may apply to a given location or device type, such as an IoT role relevant to sites with IoT devices. However, these roles still incorporate any corporate-wide policy rules the global security admin sets.

Existing solutions are typically role-centric and allow for creating separate policies for individual roles. To address these challenges, system 100 introduces the Global Policy Manager (GPM) server 110, which centralizes policy management and automates policy derivation and distribution. The GPM server 110 can generate and distribute appropriate policies based on a global policy order and site-specific requirements, managed through admin workstation 150. The proposed approach aims to make policy management more scalable, consistent, and manageable across the diverse enterprise network represented by Sites A and B and their respective network devices, overcoming the limitations of traditional role-centric solutions.

It should be appreciated that real-world enterprise networks typically involve complex policy structures that go far beyond the simplified examples often used for illustration. These networks incorporate many policy types, including organizational policies that apply broadly, departmental policies tailored to specific business units, location-specific policies that address unique geographical requirements, and building-specific policies that cater to particular facility needs. Additionally, many policies are role-agnostic, applying universally to all organizational roles.

The scale of policy management in large enterprises can be staggering. Organizations may have anywhere from 100 to 500 distinct roles, reflecting the complexity of their operations and the diverse services they provide across multiple business units. However, not all roles or policies are equally significant or applicable across all sites or devices. For example, a small sales office with access points might require enforcement of just 3-4 roles and a limited set of policies. In comparison, a large manufacturing site could necessitate enforcing over 10 roles with a more comprehensive policy set.

Merging and applying these varied policies across numerous locations and device types can present a significant challenge. The sheer volume and complexity make relying on manual processes or individual human effort impractical and error-prone. When changes are required to organizational policies, such as implementing a new security rule to be rolled out across all devices, determining the correct placement within the existing policy structure for each location and device can become daunting. This is because the policies at each location or device are typically a complex amalgamation of hundreds of rules derived from various tiers of policies.

The intricacy of this process introduces considerable risk. Even a minor error in translating or ordering policies can create security vulnerabilities. The time-consuming nature of manual policy management can also hamper an organization's ability to respond quickly to new security threats or changing business needs.

Further complicating matters is the common separation of roles between security administrators and network administrators in large enterprises. While security admins are typically responsible for defining security policies, network admins are generally tasked with implementing these policies on network devices. The division of responsibilities necessitates careful coordination between these teams, a process many organizations find challenging and time-consuming.

The complexities underscore the need for advanced, automated policy management systems that can handle the intricacies of modern enterprise networks efficiently and accurately while facilitating smooth collaboration between different administrative roles.

The disclosure's implementation introduces a security-intent-based configuration model for intuitively and consistently defining global and location-specific policies across the entire network. The proposed approach can enable security administrators to create policies considering multiple or all roles within the organization simultaneously rather than configuring policies for each role individually. This eliminates duplicating identical rules across multiple role-specific policies, streamlining the configuration process.

Aspects of the disclosure include automatically deriving role-specific policies from the user-configured corporate and location-specific policies. The auto-generated policies can be formatted to be immediately usable by edge devices for policy enforcement. Moreover, they can be tailored to suit the specific role, edge device, and device location to ensure precise and contextual policy application.

A global policy order for the configured policies is additionally proposed. The global policy order can govern rules within the derived role-specific policies. As role-specific policies can be generated based on the same global policy order, the rules can remain consistent across different roles without manual duplication, maintaining coherence throughout the network.

Further, the approach ensures efficient policy distribution by deriving and disseminating the relevant role-specific policies for each location and device type. This can be particularly beneficial for large organizations with thousands of roles, as it can eliminate the unnecessary transmission of all role-specific policies to every location and device type. Simultaneously, the system can guarantee that the location and device-specific role policies remain aligned with any broader corporate or organization-wide rules, maintaining overall policy consistency while allowing for customizations.

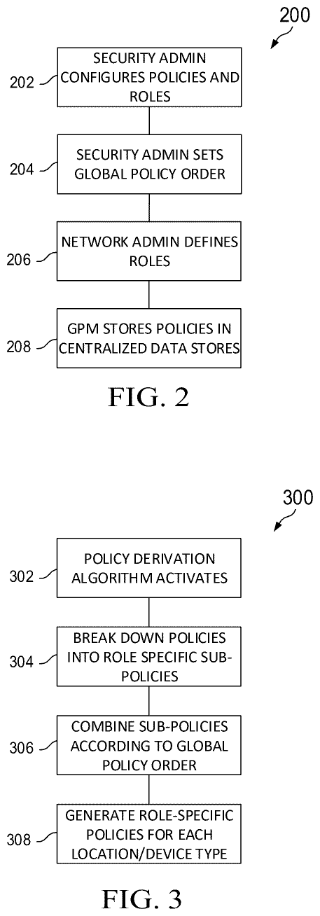

FIG. 2 illustrates a flowchart of an example method 200 for policy configuration. Method 200 illustrates an example of how the global policy order affects the merging of different policies. It is noted that all steps outlined in the flow chart of method 200 are not necessarily required and can be optional. Further, changes to the arrangement of the steps, removal of one or more steps and path connections, and addition of steps and path connections are similarly contemplated.

At step 202, a security administrator can configure policies and roles for the network using a global policy manager (GPM) system implemented through, for example, the GPM server 110. The initial phase lays the foundation for the policy management process. The security administrator begins by defining global policies that will apply across the organization, ensuring a consistent security posture throughout the network.

Table 1 illustrates an example of a global inter-network policy.

TABLE 1

| Source | Destination | Action |
|---|---|---|
| employee-dev, employee-hr, guest | printer | Allow |
| employee-dev, employee-hr | Active Directory | Allow |
| employee-dev | dev-server | Allow |
| employee-hr | hr-server | Allow |
| employee-dev | hr-server | Deny |

This table illustrates a global policy that governs access within the internal network. It defines which roles can access specific resources. For example, it allows developer employees (e.g., employee-dev), human resource (HR) employees (e.g., employee-hr), and guests (e.g., guest) to access printers (e.g., printer). Still, it restricts server access (e.g., dev-server and hr-server) based on job function.

Table 2 illustrates an example of a global internet policy.

TABLE 2

| Source | Destination | Action |
|---|---|---|
| employee-dev, employee-hr | Github | Allow |
| All Roles | Adult, Gambling | Deny |

This table shows a global policy for internet access. It allows certain employee roles (e.g., employee-dev and employee-hr) to access Github while restricting access to adult and gambling sites for all roles (e.g., All Roles), demonstrating a universal prohibition regardless of user type.

Simultaneously, the security administrator can create site-specific policies tailored to particular locations or network segments. The policies can allow for customization based on the requirements of different sites within the organization.

Table 3 illustrates an example of a site-specific policy regarding social media usage.

TABLE 3

| Source | Destination | Action |
|---|---|---|
| employee-dev | Facebook | Deny |

This table represents a site-specific policy, in this case, for social media usage. It shows a restriction for the employee-dev role, denying access to Facebook, which might be applied to a particular location or department.

Device-specific policies can also be established to address the particular needs of certain network devices.

Table 4 illustrates an example of a zero-trust policy organization-wide.

TABLE 4

| Source | Destination | Action |
|---|---|---|
| Any | Any | Deny |

This table illustrates a zero-trust policy that is applied organization-wide. The policy consists of a rule that denies all traffic from any source to any destination. This will result in a deny rule as the last rule for every role definition. So, traffic that does not match the other policies (inter-network, internet, or site-specific) will be dropped, thus enforcing zero-trust behavior. The approach ensures that only explicitly allowed traffic is permitted, while all other traffic is blocked by default, enhancing the overall security posture of the network.

An aspect of this step is defining various roles within the network. These roles, such as employee-dev, employee-hr, guest, and others, can be assigned to users or devices connecting to the network. The GPM system can allow the security administrator to consider multiple roles simultaneously during policy creation rather than configuring each role separately. The approach can streamline the process and create more comprehensive and consistent policies.

The policies and roles can be flexible and scalable, accommodating the complex needs of modern enterprise networks. By carefully defining the elements, the administrator can set the stage for efficient policy management and enforcement in the subsequent steps of the process.

At step 204, the security administrator can set the global policy order, which can involve defining the hierarchy and sequence in which policies should be applied across the network. The global policy order can act as a blueprint, guiding how different policies interact and take precedence over one another.

When establishing the order, the security administrator can carefully consider the organization's security requirements, compliance needs, and operational priorities. Policies can be ranked based on importance and scope, with more critical or broadly applicable policies typically placed higher in the order. For example, organization-wide security policies can be prioritized, followed by department-specific policies, and then location or device-specific policies.

Table 5 illustrates an example of a global policy order.

TABLE 5

| Order (hierarchy) | Policy |
|---|---|
| 1 | global inter-network policy |
| 2 | global internet policy |
| 3 | site-specific policy |
| 4 | zero-trust policy |

This table establishes the hierarchy of policy application. It prioritizes the global inter-network policy, followed by the global internet policy, and then site-specific policies, creating a clear order of precedence for policy enforcement.

The addition of the zero-trust policy as the last entry in the global policy order (Table 5) demonstrates the implementation of a default-deny approach, a principle of zero-trust architecture.

At step 206, the network administrator can define the roles applicable to different network segments. This process can involve identifying and specifying which user roles are relevant to each distinct part of the network infrastructure.

As illustrated in Tables 6 and 7, the network admin can assign different sets of roles to different sites or network segments based on each area's specific needs and user types. The granular role definition allows for more precise policy application and access control across various network parts, ensuring each segment has the appropriate user classifications for its particular requirements and security needs.

The network administrator aligns the technical network structure with the organizational roles and policies defined by the security administrator, creating a cohesive and well-structured security framework across the entire network.

Table 6 illustrates an example of roles defined at Site A 120.

TABLE 6

employee-dev
guest
employee-hr

This table lists the roles applicable to Site A, including developer employees (e.g., employee-dev), human resource (HR) employees (e.g., employee-hr), and guests (e.g., guest), representing the types of users present at this network location.

Table 7 illustrates an example of roles defined at Site B 130.

TABLE 7

employee-dev
employee-hr

This table shows the roles defined for Site B, which includes employees (e.g., employee-dev) and human resource (HR) employees (e.g., employee-hr), but lacks the guest role present in Site A.

At step 208, the GPM server 110 can store the policies the security and network administrators configure in centralized data stores. This allows for maintaining a single source of truth for all network policies across the organization. The centralized storage approach can ensure that all system components can access and refer to the same up-to-date policy information.

The GPM server 110 can utilize specialized data stores or containers to organize and store policies. These may include separate stores for organization-wide policies, location-specific policies, device-based policies, and any other deployment scope defined in the system. This structured storage approach can efficiently retrieve and manage policies based on their scope and application.

Centralized data stores can be designed to handle the complexity of modern enterprise networks. They can accommodate a large number of policies, roles, and their intricate relationships. A robust storage system can support organizations with multiple layers of policies, from broad, organization-wide rules to highly specific, device-level configurations.

Further, storing policies in centralized data can facilitate version control and change management. It can allow administrators to track policy changes over time, revert to previous versions, and maintain a clear audit trail of policy evolution. The centralized approach can also support the subsequent steps in the policy management process, providing a reliable foundation for policy derivation and distribution across the network.

In embodiments, the centralized nature of the GPM system's policy offers advantages for enterprise network management. Providing a unified view of all policies across the organization can enable administrators to quickly identify inconsistencies, redundancies, or gaps in security coverage. The holistic perspective can facilitate more informed decision-making, allowing security teams to optimize policies for better protection while reducing complexity. Further, the centralized visualization can serve as a tool for compliance audits, providing a comprehensive overview of the organization's security posture. It can also enhance collaboration between teams by offering a shared reference point for policy discussions. The centralized approach to policy can lead to more robust, coherent security strategies that can be efficiently implemented and managed across diverse network environments.

It should be appreciated that the physical storage of these policies doesn't necessarily have to be in a single, central location. The GPM system can be designed flexibly, allowing for distributed storage solutions that adapt to various organizational needs and network architectures. For example, policies can be stored across multiple locations or servers with synchronization mechanisms to ensure consistency and accessibility of policy data across the entire network.

The distributed yet synchronized approach can offer several advantages, such as improved resilience, reduced latency for geographically dispersed networks, and the ability to comply with data localization requirements. Accordingly, regardless of where the policies are physically stored, they are logically centralized from the perspective of the GPM system.

Whether centrally located or distributed, the data stores or containers organize and store different policies, including organization-wide, location-specific, and device-based policies. The structured storage approach, combined with effective synchronization, can ensure that all system components can access and refer to the same, up-to-date policy information, maintaining a single source of truth for network policies across the organization.

The flexible storage system can support the complexity of modern enterprise networks, accommodating numerous policies, roles, and their relationships while facilitating version control and change management and providing a foundation for subsequent policy derivation and distribution processes.

The global policy order can be a framework that allows for nuanced policy application. It can accommodate complex scenarios where certain policies override others in specific contexts while maintaining consistency. The order can be fine-tuned to handle exceptions and special cases without compromising the network's general security posture.

Further, the global policy order can serve as an input for the policy derivation algorithm. It can ensure that when role-specific policies are generated, they consistently reflect the intended hierarchy of rules across all roles and locations. Consistency can be useful for maintaining a coherent security strategy across diverse and complex network environments.

The ability to adjust the global policy order can give administrators a tool for adapting to changing security landscapes or organizational needs. As new threats emerge or business requirements evolve, administrators can modify the order to quickly propagate changes throughout the network, ensuring that the most critical policies are always enforced appropriately.

FIG. 3 illustrates a flowchart of an example method 300 for policy generation based on the policy configuration. Method 300 introduces an example approach to policy derivation in network security management. It is noted that all steps outlined in the flow chart of method 300 are not necessarily required and can be optional. Further, changes to the arrangement of the steps, removal of one or more steps and path connections, and addition of steps and path connections are similarly contemplated.

Method 300 builds upon the foundation laid by method 200, where policies and roles are configured more intuitively and comprehensively. While the initial approach provided by method 200 simplifies policy creation by considering multiple roles simultaneously, it can present a challenge: the resulting policies are not directly applicable to edge devices, which require role-specific policies.

To bridge this gap, method 300 implements a policy derivation algorithm that automates transforming the broader, multi-role policies into specific, role-based policies that can be directly applied to edge devices. Automating complex tasks can significantly reduce the workload of policy administrators and minimize the risk of errors that could arise from manual configuration.

The automated derivation can ensure that each role in the network receives a tailored policy set, maintaining the security intent of the original policies while adapting them to the specific requirements of individual roles and edge devices. Consequently, method 300 streamlines the policy management process and enhances the overall security posture by reducing the likelihood of misconfigurations due to human error.

At step 302, a policy derivation algorithm activates, transitioning from static policy configuration to dynamic policy generation. In implementations, the policy derivation algorithm can interpret and process the configured policies and global policy order defined in method 200.

Activating the policy derivation algorithm can initiate an automated process that transforms the high-level, intent-based policies defined by administrators in method 200 into concrete, implementable rules. It can begin by analyzing the policies stored in the data stores, considering their scope, priority, and the global policy order established during, for example, the policy configuration phase.

The policy derivation algorithm can be engineered to handle the complexity of modern enterprise networks. For example, it can process many policy types, including global, site, and device-specific policies. The algorithm can understand the intricate relationships between policies and how they should be applied across various network segments and user roles.

In an implementation, the policy derivation algorithm can resolve potential conflicts between policies. For example, it can use the global policy order stored at step 208 of method 200 as a guide to determine which policies take precedence in cases of overlap or contradiction. This can ensure that the resulting derived policies are consistent and aligned with the organization's overall security intent.

The policy derivation algorithm can also be designed to be efficient and scalable. For example, it can handle large volumes of policies and complex network structures, making it suitable for organizations of all sizes. The algorithm can operate in real time, allowing for immediate policy updates when changes are made to the base policies or global order.

Further, the policy derivation algorithm can be adaptive and context-aware. For example, it can consider network topology, device types, and user roles when deriving policies. This can ensure that the resulting policies are consistent with the global intent and relevant and appropriate for specific network segments and scenarios.

The GPM system can transition from a static repository of policies established through method 200 to a dynamic, intelligent policy management system by activating the policy derivation algorithm. This marks the beginning of the process, resulting in tailored, role-specific policies ready for distribution and enforcement across the network.

At step 304, the policy derivation algorithm can break down the configured policies established through method 200 into role-specific sub-policies. This step can transform broad, multi-role policies into more granular, role-specific rulesets that can be applied to individual network entities.

For example, the process can begin by analyzing each configured policy, whether global, site-specific, or device-specific. The policy derivation algorithm can identify the roles mentioned within each policy and create separate sub-policies for each affected role. As an example, a single global policy that applies to multiple roles like “employee-dev,” “employee-hr,” and “guest” can be broken down into three distinct sub-policies, each tailored to one of these roles.

Table 8 illustrates an example of a global inter-network policy for developer employees (e.g., employee-dev) based on Table 1, as provided by the policy derivation algorithm.

TABLE 8

| Source | Destination | Action |
|---|---|---|
| employee-dev | printer | Allow |
| employee-dev | Active Directory | Allow |
| employee-dev | dev-server | Allow |
| employee-dev | hr-server | Deny |

Table 8 focuses on rules applicable to the developer role. This sub-policy allows developer employees (e.g., employee-dev) access to printers, Active Directory, and dev-servers, while explicitly denying access to hr-servers, reflecting the role's specific needs and restrictions.

Table 9 illustrates an example of a global inter-network policy for human resource employees (e.g., employee-hr) based on Table 1, as provided by the policy derivation algorithm.

TABLE 9

| Source | Destination | Action |
|---|---|---|
| employee-hr | printer | Allow |
| employee-hr | Active Directory | Allow |
| employee-hr | hr-server | Allow |

Table 9 is tailored for HR staff. It grants access to printers, Active Directory, and hr-servers, aligning with the typical requirements of HR personnel.

Table 10 illustrates an example of a global inter-network policy for guests (e.g., guest) based on Table 1, as provided by the policy derivation algorithm.

TABLE 10

| Source | Destination | Action |
|---|---|---|
| guest | printer | Allow |

Table 10 contains one rule from the original policy, allowing guests access to printers, which is often the only internal resource guests need to access.

Table 11 illustrates an example of a global internet policy for developer employees (e.g., employee-dev) based on Table 2, as provided by the policy derivation algorithm.

TABLE 11

| Source | Destination | Action |
|---|---|---|
| employee-dev | Github | Allow |
| All Roles | Adult, Gambling | Deny |

Table 12 illustrates an example of a global internet policy for human resource employees (e.g., employee-hr) based on Table 2, as provided by the policy derivation algorithm.

TABLE 12

| Source | Destination | Action |
|---|---|---|
| employee-hr | Github | Allow |
| All Roles | Adult, Gambling | Deny |

As shown in Tables 11 and 12, developer and HR roles are granted access to Github, reflecting a common need across these employee types. Additionally, both tables include a universal rule denying access to adult and gambling sites for all roles, demonstrating how global restrictions are maintained even in role-specific policies.

Table 13 illustrates an example of a site-specific policy regarding social media usage.

TABLE 13

| Source | Destination | Action |
|---|---|---|
| employee-dev | Facebook | Deny |

Table 13 shows a specific restriction for the developer role, denying access to Facebook. This table illustrates how the policy derivation algorithm can incorporate location-specific rules into role-based policies.

The policy derivation algorithm can intelligently filter the rules within each policy, ensuring that relevant permissions and restrictions are included in each role-specific sub-policy. It can carefully preserve the intent of the original policy while making it directly applicable to individual roles.

Creating these role-specific sub-policies can allow for preparing the eventual generation of enforceable policies for network devices. By breaking down policies in this manner, the GPM system can later more easily combine and prioritize rules that apply to specific roles, regardless of which original policy they came from.

Step 304 can also help manage the complexity of policy application. For example, network devices can work with clearly defined, role-specific rules instead of interpreting broad, multi-role policies at the point of enforcement. This not only simplifies policy enforcement but can also reduce the chance of misinterpretation or incorrect application.

Further, the breakdown can allow for more granular control and customization of policies. For example, administrators can fine-tune policies for specific roles without affecting others, providing flexibility in complex network environments.

The role-specific sub-policies created in this step can serve as building blocks for the subsequent stages of policy derivation. They can provide a clear, role-oriented view of the network's security posture, setting the stage for the combination and prioritization of rules in the following steps.

At step 306, the policy derivation algorithm combines the role-specific sub-policies according to the global policy order established in method 200. This step allows for creating coherent and comprehensive policies for each role while maintaining the organization's overall security intent.

For example, the policy derivation algorithm can begin by referencing the global policy order set by the administrators in step 208. The order can serve as a blueprint for how different policies should be prioritized and combined. The algorithm takes the role-specific sub-policies created in step 304 and starts merging them for each role.

The policy derivation algorithm can carefully consider the hierarchy and relationships between different policies during the combination process. For example, it can ensure that rules from higher-priority policies take precedence over those from lower-priority ones when conflicts arise. The hierarchical approach can allow for the enforcement of organization-wide security standards while accommodating variations for specific sites, departments, or device types.

The combination process can involve logic to resolve conflicts, eliminate redundancies, and optimize the resulting policy set. For example, if two sub-policies contain conflicting rules for the same resource, the policy derivation algorithm can apply the rule from the higher-priority policy. Similarly, if multiple sub-policies contain identical or overlapping rules, the policy derivation algorithm can consolidate them to avoid unnecessary repetition.

Step 306 can also integrate role-agnostic rules that apply universally across all roles. These rules can typically be derived from the highest-priority global policies and incorporated into each role's combined policy set, ensuring a baseline level of security across the entire network.

The policy derivation algorithm can be designed to handle complex scenarios, such as when certain roles require exceptions to general rules or when site-specific policies need to override global ones in particular contexts. It can carefully balance these requirements, creating a nuanced policy set that reflects the full complexity of the organization's security needs. By the end of step 306, each role has a comprehensive set of policies that incorporates all applicable rules from various sources, properly ordered and optimized.

At step 308, the GPM system generates role-specific policies for each location and device type based on the combined sub-policies from step 306. This phase transforms the merged policy sets into concrete, actionable policies tailored to the specific needs of each role within various network contexts.

For example, the process can begin by identifying the unique combinations of roles, locations, and device types present in the network. The system can then create a distinct policy set for each combination. The granular approach can ensure that the resulting policies are precisely tailored to the specific requirements of each network segment and user type.

The GPM system can consider the attributes of different locations and device types during generation. For example, policies for a role in a high-security area might include additional restrictions compared to the same role in a standard office environment. Similarly, policies for mobile devices might differ from those for stationary workstations, even for the same role and location.

The policy derivation algorithm can also consider the capabilities and limitations of different device types when generating these policies. For example, it can ensure that the generated policies are compatible with the enforcement capabilities of the target devices, whether they are advanced next-generation firewalls or simpler network switches.

Step 308 can include optimizing the policies for efficient enforcement. For example, the GPM system may reorganize rules to improve processing speed, combine similar rules to reduce redundancy, or split complex rules into simpler ones that network devices can more easily implement.

Further, the generation process can include mechanisms to handle exceptions and special cases. For example, it can incorporate location-specific or device-specific overrides to general policies, ensuring that unique requirements are met without compromising the overall security structure.

The resulting role-specific policies are comprehensive yet focused. They contain all the rules for a given role, location, and device type combination but exclude irrelevant rules that don't apply to that specific context. The focused approach can help reduce policy bloat and improve the efficiency of policy enforcement.

Table 14 illustrates an example of a global policy for developer employees (e.g., employee-dev) at Site A 120 based on Tables 8, 11, and 12, as provided by the policy derivation algorithm.

TABLE 14

| Destination | Action |
|---|---|
| dev-server | Allow |
| hr-server | Deny |
| Active Directory | Allow |
| printer | Allow |
| Github | Allow |
| Adult, Gambling | Deny |
| Any | Deny |

Table 15 illustrates an example of a global policy for developer employees (e.g., employee-dev) at Site B 130 based on Tables 8, 11, and 12, as provided by the policy derivation algorithm.

TABLE 15

| Destination | Action |
|---|---|
| dev-server | Allow |
| hr-server | Deny |
| Active Directory | Allow |
| printer | Allow |
| Github | Allow |
| Adult, Gambling | Deny |
| Facebook | Deny |
| Any | Deny |

Tables 14 and 15 illustrate the final derived role-specific policies for the developer role at different sites (Site A 120 and Site B 130), demonstrating how the policy derivation algorithm combines and tailors policies based on global and site-specific rules.

Table 14 shows the final derived policy for developer employees (e.g., employee-dev) at Site A 120. The policy is a result of merging the applicable rules from the global inter-network policy (Table 8) and the global internet policy (Table 11) for the developer role. The policy grants access to dev-servers, Active Directory, printers, and Github, while explicitly denying access to hr-servers. It also includes the universal restriction on adult and gambling sites. The comprehensive policy set reflects the typical access needs and restrictions for a developer at a standard site.

Table 15 presents the derived policy for developer employees (e.g., employee-dev) at Site B 130. The policy includes all the rules from Table 14, but with an additional restriction: denying access to Facebook. The extra rule comes from the site-specific policy (Table 13) that applied to the Site B 130 location. Including the site-specific rule demonstrates how the policy derivation algorithm can incorporate location-based policies into the final role-specific policy, ensuring that local security requirements are met while maintaining consistency with global policies.

The difference between Tables 14 and 15 illustrates how the policy derivation algorithm can generate policies for specific locations while maintaining a consistent base of global rules. This approach allows centralized policy management with the flexibility to accommodate site-specific security needs, resulting in tailored, comprehensive, and enforceable policies for each role at each location.

The ordering of rules within Tables 14 and 15 reflects the global policy order defined by the security administrator in Table 5 at step 204 of method 200. The hierarchical arrangement is evident in how rules controlling infrastructure usage, such as access to dev-servers and printers, are positioned above rules governing internet access and other external sites. The ordering ensures that internal access controls are evaluated before less essential external access rules, maintaining the intended security priorities across the network.

The policy derivation process can be designed to be comprehensive and efficient. For example, for any given location or device type, the GPM system can derive and distribute the role-specific policies that apply to that particular context. The targeted approach prevents unnecessary policy bloat and ensures that each network segment or device receives relevant security rules. However, each role-specific policy, regardless of its target location or device, can incorporate corporate-wide rules and any applicable site-specific policy rules. The integration ensures a consistent security baseline across the organization while allowing for local variations.

The zero-trust policy is reflected in Tables 14 and 15 as the last rule: “Destination: Any, Action: Deny”. The final rule in the derived policies ensures that any traffic not explicitly allowed by the preceding rules is denied by default. The approach enhances the network's security posture by requiring explicit permission for all network activities rather than allowing any traffic not specifically prohibited.

The placement of the rule at the end of each derived policy allows the more specific rules to take precedence, permitting necessary network operations while still providing a comprehensive safety net that blocks any unexpected or potentially malicious traffic.

The implementation of zero-trust principles showcases how the Global Policy Manager (GPM) system can incorporate advanced security concepts into its policy derivation process, resulting in a more secure and tightly controlled network environment.

By the end of step 308, the GPM system has produced a set of highly specialized, ready-to-implement policies. These policies represent the final product of the policy derivation process, embodying the organization's security intent in a form that can be directly applied to network devices for enforcement.

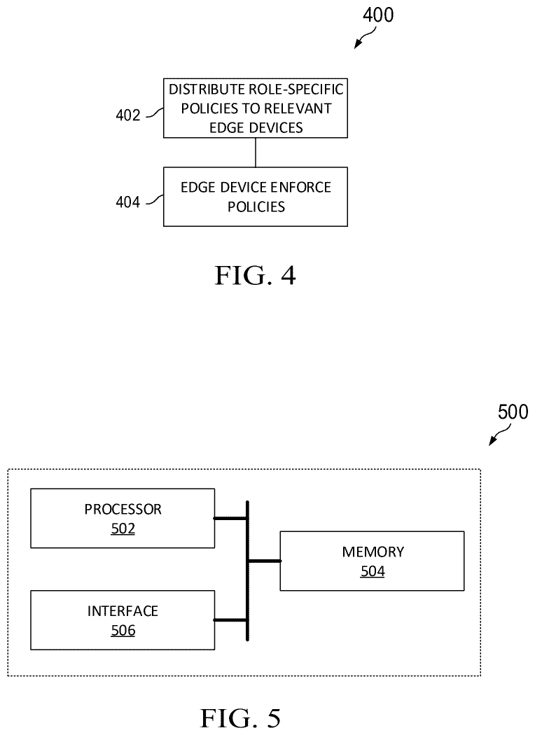

FIG. 4 illustrates a flowchart of an example method 400 for policy distribution and enforcement. Method 400 illustrates an example of how derived policies are distributed to relevant network devices.

It is noted that all steps outlined in the flow chart of method 400 are not necessarily required and can be optional. Further, changes to the arrangement of the steps, removal of one or more steps and path connections, and addition of steps and path connections are similarly contemplated.

At step 402, the GPM server 110 distributes the generated role-specific policies to the relevant edge devices across the network. This step marks the transition from policy generation to implementation, ensuring that carefully crafted security rules are implemented.

For example, the distribution process can begin with the GPM system identifying which policies to send to each edge device. The determination can be based on the device's location, type, and the roles it needs to support. For example, a gateway in a particular office location can receive policies relevant to that office's roles and device types.

The GPM system can employ intelligent distribution mechanisms for efficient and secure policy deployment. It may use differential updates, sending policy changes rather than entire policy sets, to minimize network traffic and reduce the time for policy updates. The approach can be particularly beneficial in large, distributed networks where bandwidth conservation is crucial.

Security is a paramount concern during the distribution phase. The GPM system can employ robust encryption and authentication measures to protect the integrity and confidentiality of the policies as they traverse the network. This can ensure that the policies cannot be intercepted, altered, or misdirected during transmission.

The distribution process can also include mechanisms for verifying the successful receipt and application of policies on edge devices. The GPM system can require device acknowledgments upon successful policy implementation, allowing real-time monitoring of the policy deployment status across the network.

In cases where immediate policy updates are critical, the GPM system can prioritize the distribution of certain high-priority policies. This can ensure that crucial security changes are propagated rapidly across the network, enhancing the organization's ability to respond quickly to emerging threats or changing compliance requirements.

The GPM system can be designed to handle various network conditions and device states during distribution. For example, it can include retry mechanisms for devices that may be temporarily offline or unreachable, ensuring that all devices eventually receive the latest policies. It can also manage version control, ensuring that devices have the most up-to-date policy set and can roll back to previous versions.

For organizations with geographically dispersed networks, the distribution process can involve a hierarchical approach. For example, policies can be sent to regional distribution points first, which then handle the local distribution to individual devices. This approach can improve efficiency and reduce the load on central systems.

By the end of this step, all relevant edge devices across the network have received their specific, role-based policies. These devices are equipped with the latest security rules and ready to enforce them and maintain the organization's desired security posture across all network segments and user types.

At step 404, the edge devices enforce the distributed role-specific policies, marking the final stage in the policy management lifecycle. This step transforms the carefully crafted and distributed policies into active security measures that govern network access and behavior.

Upon receiving the new policies, each edge device (e.g., a gateway, switch, or wireless access point) can begin implementing these rules. The devices can interpret the policy instructions and translate them into device-specific configurations and access control lists. The translation ensures that the policies are enforced optimally for each device's specific hardware and software capabilities.

The enforcement process can be dynamic and context-aware. For example, as users and devices connect to the network, edge devices can evaluate their attributes, such as user identity, device type, location, and authentication method, to assign the appropriate role. Once a role is assigned, the corresponding policy can be immediately applied, controlling what resources the user or device can access and what actions they can perform on the network.

Edge devices can continually monitor network traffic and user activities, comparing them against the enforced policies in real time. This constant vigilance can allow for immediate policy enforcement, blocking unauthorized access attempts, restricting prohibited activities, and allowing permitted communications as defined by the policies. Enforcement can involve more nuanced actions (not limited to binary actions) like traffic shaping, quality of service adjustments, or triggering additional authentication steps.

In scenarios where policies dictate different rules based on time of day, network load, or other variable factors, edge devices can dynamically adjust their enforcement. This flexibility allows policies to adapt to changing conditions without requiring constant manual intervention.

The enforcement stage can include logging and reporting functions. Edge devices typically maintain detailed logs of policy enforcement actions, recording policy violations and successful applications. These logs can be used for security audits, compliance reporting, and ongoing refinement of the organization's security posture.

In cases where a policy conflict arises, or an unexpected scenario occurs, edge devices can be configured to fail securely by, for example, defaulting to the most restrictive policy to ensure network security is not compromised. Advanced edge devices can include capabilities for anomaly detection, identifying and responding to patterns of behavior that may indicate a security threat, even if they don't explicitly violate a written policy.

In zero-trust network architecture environments, edge devices can continually verify every access request, regardless of source or destination, ensuring that trust is never assumed and always validated against the current policies.

The HR employee role and IoT role policies are derived and distributed exclusively to Site A 120, as these roles may not be relevant or may have different requirements at other locations. In contrast, the developer role policy is distributed to Site A 120 and Site B 130. The differentiated distribution demonstrates the system's ability to tailor policy applications based on each location's specific needs and structure while maintaining overall organizational security standards.

Accordingly, the proposed approach leverages a security-intent-based configuration model and a global policy ordering system. This approach can ensure consistent policy enforcement across the entire network, regardless of its complexity or scale.

In an implementation, the GPM system empowers security administrators to create comprehensive policies encompassing various organizational roles. The proposed approach eliminates redundant rule-setting across distinct roles, significantly streamlining the policy creation. The GPM system can adeptly handle multiple organizational, departmental, and location-specific policy layers, addressing the complex challenge of maintaining consistency and a clear security stance for each user role. It can accomplish this by seamlessly generating role-specific policies immediately applicable to edge devices, with each policy customized to suit the specific role, device, and location.

The GPM system can positively shift network security management efficiency. For example, it can allow security administrators to focus their expertise on crafting complex global policies without getting bogged down by network deployment intricacies. Simultaneously, network administrators can concentrate on activating the network, managing user roles, and localizing policies for different locations and device types.

The GPM system's approach can handle merging and correctly ordering policies, ensuring that each rule is appropriately placed and that role-specific policies are systematically generated for edge devices. Adherence to a single global policy sequence can align security objectives with network configuration requirements. This can ensure uniform rule ordering within role-specific policies and eliminate the need for repetitive rule-setting across various roles.

A strength of the proposed GPM system lies in its ability to cater to individual roles and locations without overwhelming edge devices with unnecessary data. While large organizations may have numerous roles, the GPM system can recognize that distributing all role-specific policies to every network node can be impractical. Instead, the proposed approach guarantees that relevant policies and roles are applied to each location and device type while maintaining alignment with broader organizational rules. The targeted approach can ensure optimal performance and relevance of security policies across the network.

Accordingly, the proposed GPM system represents an advancement in enhancing user experience and implementing zero-trust network strategies. Its ability to efficiently manage complex, multi-layered security policies while maintaining consistency and relevance across diverse network environments adds significant value to next-generation cloud solutions and initiatives.

Building upon the network architecture system 100 described in FIG. 1 and the policy configuration process outlined in FIG. 2, let's consider a more complex example demonstrating the flexibility of the GPM system. This scenario involves an organization with two distinct sites: Santa Clara (which we can consider as Site A 120) and Dubai (which we can consider as Site B 130), each equipped with one or more gateways and access points. This setup illustrates how security policies can be customized based on device location and type, showcasing the granularity of the system in handling diverse network environments. This example examines three policies: P1, P2, and P3.

Table 16 illustrates an example of a global policy (Policy 1) targeting gateway devices across all sites.

TABLE 16

| | Source | Destination | Services/Apps | Action |
|---|---|---|---|---|
| Rule 1 | All Roles | Any | App: Netflix | Deny |
| Rule 2 | Employee, Guest | Any | UDP 66 | Deny |
| Rule 3 | Employee, Guest | Any | SVC_DNS, | Allow |
| | | | SVC_DHCP | |
| Rule 4 | Employee | BYOD | SVC_HTTPS | Deny |
| Rule 5 | Employee | IP_3.3.3.3 | SVC_HTTPS | Allow |

Policy P1 is a global policy that applies to all Gateway devices across all sites. It includes several rules: Netflix access is denied for all roles, UDP 66 is blocked for employees and guests, DNS and DHCP services are permitted for employees and guests, HTTPS access Bring Your Own Device (BYOD) (i.e., the practice where employees are allowed or encourage to use personal devices) is denied for employees, and HTTPS access to a specific IP (3.3.3.3) is allowed for employees.

Table 17 illustrates an example of a global policy (Policy 2) targeting gateway and access point devices at the Dubai site.

TABLE 17

| | Source | Destination | Services/Apps | Action |
|---|---|---|---|---|
| Rule 1 | All Roles | Any | App: Gambling | Deny |

Policy P2, “Block Gambling,” is more localized. It consists of a rule denying access to gambling applications for all roles.

Table 18 illustrates an example of a global policy (policy 3) targeting access point devices across all sites.

TABLE 18

| | Source | Destination | Services/Apps | Action |
|---|---|---|---|---|
| Rule 1 | Employee | Any | App: YouTube | Deny |

Policy 3, “WIFI users,” includes a rule denying employees YouTube access on WiFi networks.

The policy configuration follows steps 202-208 of FIG. 2. At step 202, the security admin configures these three policies. At step 204, the global policy order is set as P1>P3>P2 to determine how policies are applied and conflicts resolved.

Table 19 illustrates an example of a global policy order.

TABLE 19

| Order (hierarchy) | Devices | Scope |
|---|---|---|
| P1 | Gateway devices | Global (All Sites) |
| P3 | Access Point devices | Global (All Sites) |
| P2 | Gateway and Access Point devices | Dubai Only |

Step 206 involves the network admin defining roles for each site, though specific roles beyond the ‘Employee’ role aren't detailed in this example. At step 208, these policies are stored in the GPM server 110's centralized data stores.

As detailed in FIG. 3, the policy derivation algorithm can process these policies. It activates (step 302), analyzes the stored policies, and breaks them into role-specific sub-policies (step 304). The algorithm then combines these sub-policies according to the global policy order (step 306) and generates final role-specific policies for each location and device type (step 308). This process considers global policies (P1 for Gateways, P3 for APs), site-specific policies (P2 for Dubai only), and device-specific applications (different policies for Gateways vs APs).

The resulting derived policies demonstrate the system's capability to create tailored, enforceable policies.

Table 20 illustrates the derived policy for the employee role at the Dubai site for gateway and access point devices.

TABLE 20

| Gateway | Access Point |
|---|---|
| Policy P1 Corp Users - Rule 1 | Policy P3 WIFI users - Rule 1 |
| Policy P1 Corp Users - Rule 2 | Policy P2 Block Gambling - Rule 1 |
| Policy P1 Corp Users - Rule 3 | |
| Policy P1 Corp Users - Rule 4 | |
| Policy P2 Block Gambling - Rule 1 | |

For example, the employee policy rules for Dubai would include all rules from P1 for the Gateway, the gambling restriction from P2, and the WiFi-specific rule from P3 for APs.

Table 21 illustrates the derived policy for the same employee role at the Santa Clara site for gateway and access point devices.

TABLE 21

| Gateway | Access Point |
|---|---|
| Policy P1 Corp Users - Rule 1 | Policy P3 WIFI users - Rule 1 |
| Policy P1 Corp Users - Rule 2 | |
| Policy P1 Corp Users - Rule 3 | |
| Policy P1 Corp Users - Rule 4 | |

In contrast, Santa Clara's employee role would not include the gambling restriction. This differentiation showcases how the system adapts policies to each site's requirements while maintaining organizational security standards.

This example illustrates the practical application of the GPM system in a complex, multi-site enterprise network environment. It demonstrates how the system handles varying scopes and device-type applicability, allowing for global consistency while accommodating site-specific requirements. Such flexibility is crucial in modern enterprise networks where security needs vary significantly across locations and network access methods.

FIG. 5 illustrates a block diagram of an example computing device 500, according to certain implementations. The implementations described herein for the GPM server 110 or GPM system can be implemented using computing devices. Computing device 500 includes a processor 502, a memory 504, and an interface 506, which may (or may not) be arranged as shown. Computing device 500 may include additional components that are not shown. For example, computing device 500 may include a power supply to provide power to the computing device 500.

Computing device 500 can be, for example, a server (e.g., a blade-server in a blade-server chassis, a rack server in a rack, etc.), a desktop computer, a mobile device (e.g., laptop computer, smartphone, personal digital assistant, tablet computer, automobile computing system, or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, or a digital sensor. In implementations, any or all of the aforementioned can be combined to create a system of such devices or partitioned into separate logical devices, collectively called computing device 500. Other types of computing devices may be used without departing from the scope of implementations described herein.

In an implementation, processor 502 is an integrated circuit, a single-core processor, a microcontroller, or a multi-core processor for processing instructions. Processor 502 may be a general-purpose processor configured to execute program code included in software executing on computing device 500. Processor 502 may be a special-purpose processor where instructions are incorporated into the processor design. Although one processor 502 is shown in FIG. 5, computing device 500 may include any number of processors without departing from the scope of implementations disclosed herein. In implementations, the benchmark program is configured to provide a metric associated with the processor 502.

In an implementation, memory 504 is volatile memory, non-volatile memory, or both. In implementation, memory 504 is a random-access memory (RAM), cache memory, persistent storage, a hard disk, an optical drive, flash memory, or the like. In an implementation, memory 504 includes a data repository for storing data structures or policy containers storing any amount of data (e.g., information). In implementation, a data repository is any type of storage unit or device (e.g., a file system, database, collection of tables, RAM, or any other storage mechanism or medium) for storing data. Further, the data repository may include multiple different storage units or devices. The multiple storage units or devices may or may not be the same type or located at the exact physical location. In implementations, memory 504 is configured to store instructions to be executed by processor 502 to perform the methods disclosed herein.

In an implementation, interface 506 is a touchscreen, a keyboard, a mouse, a microphone, a touchpad, an electronic pen, a motion sensor, or any other input device. implementations, interface 506 is a screen (e.g., a liquid crystal display (LCD), a plasma display, a touch screen, a cathode ray tube (CRT) monitor, a projector, or other display device), a printer, external storage, or any other output device. Interface 506 may allow a user to interact with other devices, such as the admin workstation 150, the various components in Site A 120 and Site B 130. In implementation, interface 506 is an input and an output device. Interface 506 may be locally or remotely coupled to the processor 502 and memory 504. Many different types of computing devices exist, and the aforementioned interface 506 may take other forms.

In an implementation, interface 506 may facilitate coupling computing device 500 to a network (e.g., a local area network (LAN), a wide area network (WAN) such as the Internet, mobile network, or any other type of network) or to another device, such as another computing device as shown in the example of FIG. 1. Interface 506 may perform or facilitate receipt or transmission of wired or wireless communications using wired or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 1G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

In an implementation, interface 506 may be a Global Navigation Satellite System (GNSS) receiver or transceiver used to determine the location of computing device 500 based on receiving one or more signals from one or more satellites associated with GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement. Therefore, the basic features here may easily be substituted for improved hardware or firmware arrangements as they are developed.

Methods described herein can be implemented using computer-executable instructions stored in memory 504 or otherwise available from computer-readable media. Such instructions can include, for example, instructions and data that cause or otherwise configure processing devices, a computer, a special-purpose computer, or a processing device to perform a particular function or group of functions. Portions of computer resources used can be accessible over a network. The computer-executable instructions may be, for example, binaries and intermediate format instructions such as assembly language, firmware, source code, etc. Examples of computer-readable media that may be used to store instructions, information used, or information created during methods according to described examples include magnetic or optical disks, flash memory, USB devices provided with non-volatile memory, networked storage devices, or the like.

All or any portion of the components of computing device 500 may be implemented in circuitry. For example, the components can include or can be implemented using electronic circuits or other electronic hardware, which can include one or more programmable electronic circuits (e.g., microprocessors, GPUs, DSPs, CPUs, or other suitable electronic circuits) or can include or be implemented using computer software, firmware, or any combination thereof, to perform the various operations described herein. In some aspects, computer-readable storage devices, mediums, and memories can include a cable or wireless signal containing a bit stream and the like.

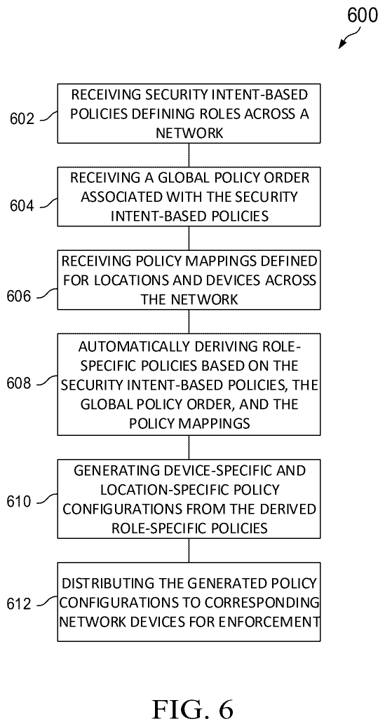

FIG. 6 illustrates a flowchart for an implementation method 600 for managing network security policies. In an implementation, method 600 is a computer-implemented method. It is noted that all steps outlined in the flow chart of method 600 are not necessarily required and can be optional. Further, changes to the arrangement of the steps, removal of one or more steps and path connections, and addition of steps and path connections are similarly contemplated.

At step 602, a GPM server receives security intent-based policies that define roles across a network. The policies may encompass organizational, departmental, and location-specific policies, providing a comprehensive framework for network security.

At step 604, the GPM server receives a global policy order associated with the security intent-based policies. The order allows for determining how policies are combined and prioritized.

At step 606, the GPM server receives policy mappings defined for locations and devices across the network. The mappings can contain information that associates specific security intent-based policies with particular network locations or device types, ensuring that policies are appropriately applied throughout the network infrastructure.

At step 608, the GPM server automatically derives role-specific policies. In an implementation, the process is based on the previously received security intent-based policies, the global policy order, and the policy mappings. The derivation process can include breaking down the security intent-based policies into role-specific sub-policies and then combining these sub-policies according to the global policy order. This step ensures that each role within the network has a tailored set of policies that align with the overall security strategy.

At step 610, once the role-specific policies are derived, the GPM server generates device-specific and location-specific policy configurations. The generation process can involve filtering the derived role-specific policies to include those policies that are relevant to specific devices or locations. The targeted approach ensures that each network component receives the policies for its operation and security requirements.

At step 612, the GPM server distributes the generated policy configurations to corresponding network devices for enforcement. The distribution ensures that the carefully crafted and tailored policies are implemented across the network.

While not explicitly shown, method 600 can include additional steps. For example, the GPM server can receive policy update requests, automatically determine affected devices and locations based on these requests and the policy mappings, update the relevant policy configurations, and distribute the updated configurations to the affected devices. Further, the method 600 can include steps for updating the global policy order, which can trigger an automatic regeneration and redistribution of policy configurations based on the updated order. The additional steps can help ensure that the network security policies remain current and effective in response to changing requirements or security landscapes.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for managing network security policies, the computer system comprising:
a processor; and
a non-transitory memory storing instructions that, when executed by the processor, cause the system to:
receive security intent-based policies defining roles across the network,
receive a global policy order associated with the security intent-based policies,
receive policy mappings defined for locations and devices across the network,
automatically derive role-specific policies based on the security intent-based policies, the global policy order, and the policy mappings,
generate device-specific and location-specific policy configurations from the derived role-specific policies, and
distribute the generated policy configurations to corresponding network devices for enforcement.

2. The computer system of claim 1, wherein the instructions further cause the system to determine relevant policy configurations for each network device based on type and location.

3. The computer system of claim 1, wherein automatically deriving role-specific policies comprises applying the global policy order to ensure correct rule ordering for various locations across the network.

4. The computer system of claim 1, wherein the instructions further cause the system to:
receive a policy update request;
automatically determine affected devices and locations based on the policy update request and the policy mappings;
update the relevant policy configurations; and
distribute the updated policy configurations to the affected devices.

5. The computer system of claim 1, wherein generating device-specific and location-specific policy configurations comprises filtering the derived role-specific policies to include policies relevant to a specific device or location.

6. The computer system of claim 1, wherein the instructions further cause the system to:
update the global policy order; and
automatically regenerate and redistribute policy configurations based on the updated global policy order.

7. The computer system of claim 1, wherein the security intent-based policies comprise at least one of organizational policies, departmental policies, and location-specific policies.

8. A non-transitory computer-readable medium storing instructions that, when executed by a processor, cause the processor to manage network security policies, the method comprising:
receiving security intent-based policies defining roles across a network;
receiving a global policy order associated with the security intent-based policies;
receiving policy mappings defined for locations and devices across the network;
automatically deriving role-specific policies based on the security intent-based policies, the global policy order, and the policy mappings;
generating device-specific and location-specific policy configurations from the derived role-specific policies; and
distributing the generated policy configurations to corresponding network devices for enforcement.

9. The non-transitory computer-readable medium of claim 8, wherein automatically deriving role-specific policies comprises:
breaking down the security intent-based policies into role-specific sub-policies; and
combining the role-specific sub-policies according to the global policy order.

10. The non-transitory computer-readable medium of claim 8, wherein the method further comprises:
receiving a policy update request;
automatically determining affected devices and locations based on the policy update request and the policy mappings;
updating the relevant policy configurations; and
distributing the updated policy configurations to the affected devices.

11. The non-transitory computer-readable medium of claim 8, wherein generating device-specific and location-specific policy configurations comprises filtering the derived role-specific policies to include policies relevant to a specific device or location.

12. The non-transitory computer-readable medium of claim 8, wherein the method further comprises:
updating the global policy order; and
automatically regenerating and redistributing policy configurations based on the updated global policy order.

13. The non-transitory computer-readable medium of claim 8, wherein the security intent-based policies comprise at least one of organizational policies, departmental policies, and location-specific policies.

14. A computer-implemented method for managing network security policies, the computer-implemented method comprising:
receiving, by a Global Policy Manager (GPM) server, security intent-based policies defining roles across a network;
receiving, by the GPM server, a global policy order associated with the security intent-based policies;
receiving, by the GPM server, policy mappings defined for locations and devices across the network;
automatically deriving, by the GPM server, role-specific policies based on the security intent-based policies, the global policy order, and the policy mappings;
generating, by the GPM server, device-specific and location-specific policy configurations from the derived role-specific policies; and
distributing, by the GPM server, the generated policy configurations to corresponding network devices for enforcement.

15. The computer-implemented method of claim 14, wherein the security intent-based policies comprise at least one of organizational policies, departmental policies, and location-specific policies.

16. The computer-implemented method of claim 14, wherein automatically deriving role-specific policies comprises:
breaking down the security intent-based policies into role-specific sub-policies; and
combining the role-specific sub-policies according to the global policy order.

17. The computer-implemented method of claim 14, wherein generating device-specific and location-specific policy configurations comprises filtering the derived role-specific policies to include policies relevant to a specific device or location.

18. The computer-implemented method of claim 14, further comprising:
receiving a policy update request;
automatically determining affected devices and locations based on the policy update request and the policy mappings;
updating the relevant policy configurations; and
distributing the updated policy configurations to the affected devices.

19. The computer-implemented method of claim 14, wherein the policy mappings comprise information associating specific security intent-based policies with network locations or device types.

20. The computer-implemented method of claim 14, further comprising:
updating the global policy order; and
automatically regenerating and redistributing policy configurations based on the updated global policy order.
